(19) United States
(12) Patent Application Publication
(10) Pub. No.: US 2001/0033255 A1
(43) Pub. Date: Oct. 25, 2001

(54) Method for driving an AC type PDP

(76) Inventors: Akira Otsuka, Kawasaki (JP); Takashi Sasaki, Kawasaki (JP)

Correspondence Address: STAAS & HALSEY, Suite 500, 700 Eleventh Street, N.W., Washington, DC, 20001, US

(21) Appl. No.: 09/731,797

(22) Filed: Dec. 8, 2000

(30) Foreign Application Priority Data
Apr. 25, 2000 (JP) 2000-123583

(51) Int. Cl. G09G 3/28

(52) U.S. Cl. 345/60

(57) ABSTRACT

A method for driving an AC type PDP is provided in which a display discharge is generated by a low voltage so that the power consumption can be reduced, and the light emission efficiency can be improved. A voltage pulse train Vi having alternating polarity is applied between the display electrodes so that the display discharge is generated at a time interval below 2 μ sec which space charge causes an active priming effect and that the polarity of the wall voltage between the display electrodes switches for every display discharge.

### BACKGROUND OF THE INVENTION

1. Field of the Invention

The present invention relates to a method for driving an AC type plasma display panel (PDP).

In a PDP, increase of power consumption due to a large size or a high definition is becoming a problem in designing a driving device and in taking measures against heat. It is necessary to suppress the power consumption to the same extent as that of a CRT while maintaining the luminance.

2. Description of the Prior Art

An AC type PDP has a structure of memory function by covering display electrodes with a dielectric. The display electrode is an electrode that becomes an anode or a cathode in display discharge that is a discharge for lighting (light emission). In a three-electrode surface discharge type that is a typical color PDP, address electrodes for addressing are arranged so as to cross the display electrodes.

FIG. 10 is a diagram showing a concept of the conventional method for driving an AC type PDP and shows voltage change in the display discharge.

In the display of an AC type PDP, the addressing is performed for forming the state where only the cell to be lighted has a sufficient charge, and then a sustaining pulse train having alternating polarity is applied to the cells.

A sustaining voltage Vs that is a peak value of the conventional sustaining pulse satisfies the following relationship.

VF−Vw<Vs<VF

VF is a discharge starting voltage.

Vw is a wall voltage.

In the cells having a wall charge, the wall voltage Vw is added to the applied voltage Vi. Therefore, a cell voltage that is applied to the cell (also referred to as an effective voltage) Vc can exceed a discharge starting voltage Vf so that a discharge occurs, and a light emission is generated. Since the polarity of the wall charge that is reformed by the discharge is opposite to the previous one, the reform causes a drop of the cell voltage Vc and stop of discharge. However, the applied voltage Vi is maintained at the sustaining voltage Vs for a while, so the space charge is drawn up to the display electrode and the wall charge is further accumulated. The feature of the conventional method is in that the pulse width Tc′ of the sustaining pulse is relatively long such as 3-4 μsec so that sufficient wall charge can be accumulated. Space charge (quasi-stable particle) is generated along with the discharge, and the discharge starting voltage Vf once drops apparently. However, it returns to the substantially original level after a while at falling of the sustaining pulse. After that, when a sustaining pulse having the opposite polarity is applied, a discharge occurs again so as to reform the wall charge. From then on, the discharge occurs every time when the sustaining pulse is applied in the same way. Since the period of the discharge is approximately 4-5 μsec, the lighting becomes continuous visually.

In a DC type PDP, after applying a sufficiently high voltage to the cells for generating the discharge, a pulse train having a period that is shorter than the time until the space charge disappears is applied so as to sustain the lighting state. This driving method is called a pulse memory driving method. This pulse memory driving method can be applied to an AC type PDP as disclosed in Japanese unexamined patent publication 11-282415. Namely, Paragraphs 0112-0116 of the publication and FIG. 6 disclose a driving method in which a sustaining pulse train having alternating polarity is applied. The pulse width is 1.3 μsec, and the suspending period is 0.7 μsec. At the rising edge (front edge) of the first sustaining pulse, a discharge is generated for forming the wall charge. At the falling edge (the trailing edge), a self-erasing discharge is generated by the wall charge. While the space charge due to the self-erasing discharge is remained, a second sustaining pulse is applied so that the front edge discharge that does not depend on the wall charge and the trailing edge discharge due to the wall charge are generated sequentially. From then on, two discharges are generated for each sustaining pulse in the same way.

In an AC type PDP, it is known that the light emission efficiency is increased when the applied voltage for display discharge is lowered so that the discharge intensity is decreased. One of the reasons is a decrease of the power consumption by the driving circuit and by a resistance of the display electrodes, and another reason is a relief of the excitation saturation of the gas light emission or the fluorescent material light emission. However, if the applied voltage is lowered simply, stability of display may be deteriorated. In order to perform secure drive with a low applied voltage, the cell structure and the material selection should be reconsidered substantially. Actually, it is difficult to enhance the light emission efficiency simply by lowering the applied voltage.

When using the conventional driving method of an AC type PDP as explained above with reference to FIG. 10 (hereinafter, referred to as a wall charge memory driving method), only approximately 1000 pairs of the sustaining pulses (one pair consists of a pulse with a first polarity and a succeeding pulse with a second polarity) can be applied per one field for avoiding overheating of a panel and driving circuits due to the display discharge. The upper limit of the number of pulses for securing a pulse width of the sustaining pulse is also approximately 1000 pair. Because of the limit of the pulse number, it is difficult to reproduce faithfully the gradation, especially in the low luminance range.

In addition, in the driving method disclosed in Japanese unexamined patent publication No. 11-282415, a lot of wall charge is formed that causes the self-erasing discharge, so the pulse width and the peak value should be set correspondingly. Though the pulse width can be shortened much more than in the wall charge memory driving method, it is difficult to obtain a large effect in reducing the applied voltage (in improving the light emission efficiency).

### SUMMARY OF THE INVENTION

The object of the present invention is to reduce the power consumption by generating display discharge by as low voltage as possible, so that the light emission efficiency is improved. Another object is to realize a high definition display in which pseudo-edges of a moving image are not conspicuous.

In the present invention, as shown in FIG. 1, both the wall charge and the space charge are utilized for generating plural display discharges continuously. In order to utilize the wall charge, a driving voltage Vi of a voltage pulse train having a waveform of alternating polarity is applied between the display electrodes every time when a display discharge occurs, so that the polarity of the wall voltage Vw between the display electrodes switches. In a typical cell structural condition, when the charge accumulating time Ta after each display discharge is more than 0.3 μsec, a sufficient wall charge can be formed that is necessary for the next display discharge. If the time after the discharge is shorter than approximately 2 μsec, a sufficient quantity of the space charge generates a priming effect. Therefore, the period Tc of the display discharge should be within the range of 0.3-2.0 μsec. If a suspending period Tb is provided while the applied voltage is the ground level so as to prevent a short circuit of the driving device, the suspending period Tb should be shorter than 0.3 μsec so as to avoid the neutralization and annihilation of the wall charge.

In an AC type PDP, forming of the wall charge causes a drop of the cell voltage Vc, so that the display discharge cannot last long. Therefore, if the pulse memory driving method for a DC type PDP is applied to an AC type PDP, a stable driving cannot be expected. It is because that the variation of the space charge quantity can be generated easily. The presence of the wall charge may also cause the instability. The present invention utilizes the wall charge positively so as to take advantage of an AC type PDP.

As shown in FIG. 1, the value of the discharge starting voltage Vf is dropped from Vf1 to Vf2 due to the space charge, and an appropriate wall voltage Vw is generated when the application of the voltage pulse train (Vi) starts. Since the discharge starting voltage Vf drops, the display discharge is generated at a lower voltage than in the wall charge memory driving method. Namely, the discharge intensity can be decreased and the light emission efficiency can be improved. Since the wall voltage Vw at the trailing edge of the pulse is sufficiently lower than Vf, the self-erasing discharge does not occur, and the wall charge remains. If a pulse having the opposite polarity to the previous time is applied in the state where the discharge starting voltage Vf is kept at a low value in the space charge that was generated by the display discharge, the display discharge is generated again at a voltage lower than the wall charge memory driving method. This driving method of the present invention in which the occurrence number of the display discharge corresponds to the luminance is referred to as an “AC pulse memory driving method” hereinafter.

In an AC pulse memory driving method, the period Tc of the display discharge is approximately 2 μsec at most, and heating can be suppressed by decreasing the discharge intensity. Therefore, the limitation of the number of pulses is not strict both in a temporal manner and for a power consumption. Specifically, 2000 pair of pulses can be applied for one field. Thus, a large improvement of the gradation can be realized.

The waveform of the voltage pulse that is applied to a PDP is distorted due to a resistance, an inductance, a stray capacitance and other factors. If the discharge current is small, the distortion is small, so that a dependency of an operation voltage margin and the luminance on a display load factor becomes small. In an AC pulse memory drive, one discharge current is smaller by 30-50% than in the wall charge memory drive, and the peak current can be reduced to the same extent. When the peak current is reduced, good operation and display characteristics can be obtained even if a resistance of the driving circuit and the panel increases. Therefore, a smaller power source or a driving element can be used or a thickness of the electrodes can be decreased for reducing the cost of a display device.

### BRIEF DESCRIPTION OF THE DRAWINGS

FIG. 1 is a diagram showing a concept of an AC pulse memory drive according to the present invention.

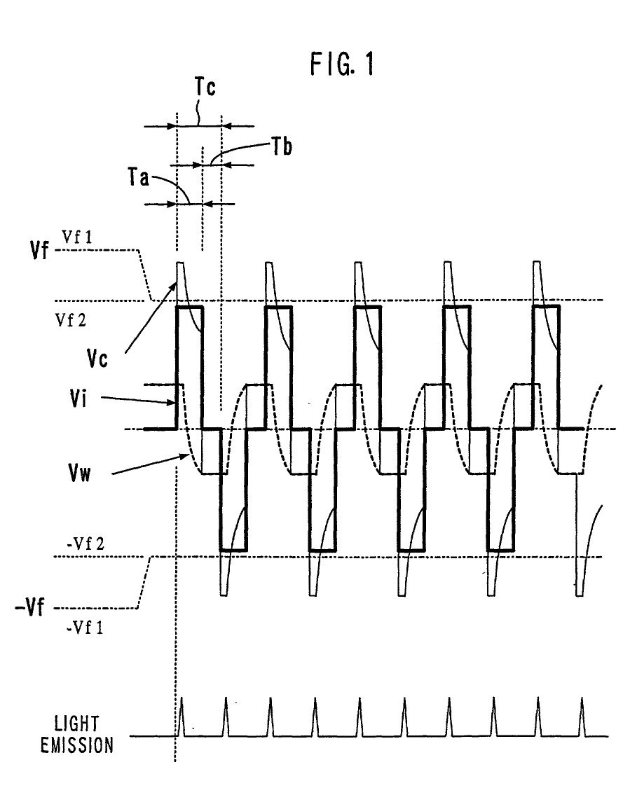

FIG. 2 is a block diagram of a display device according to the present invention.

FIG. 3 is a diagram showing a cell structure of a PDP according to the present invention.

FIG. 4 is a diagram showing voltage waveforms according to a first example of the present invention.

FIG. 5 is a diagram showing an example of the display order of subfields.

FIG. 6 is a diagram showing voltage waveforms according to a second example of the present invention.

FIG. 7 is a diagram showing voltage waveforms according to a third example of the present invention.

FIG. 8 is a diagram showing the display order of the subfield according to a fourth example.

FIG. 9 is a diagram showing voltage waveforms of the fourth example.

FIG. 10 is a diagram showing a concept of the conventional method for driving an AC type PDP.

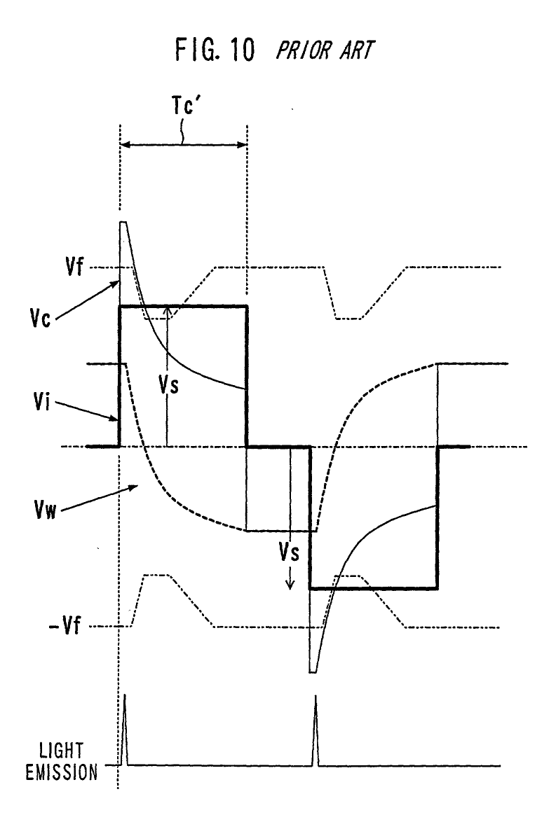

### DESCRIPTION OF THE PREFERRED EMBODIMENTS

Hereinafter, the present invention will be explained more in detail with reference to embodiments and drawings.

[Structure of a Device]

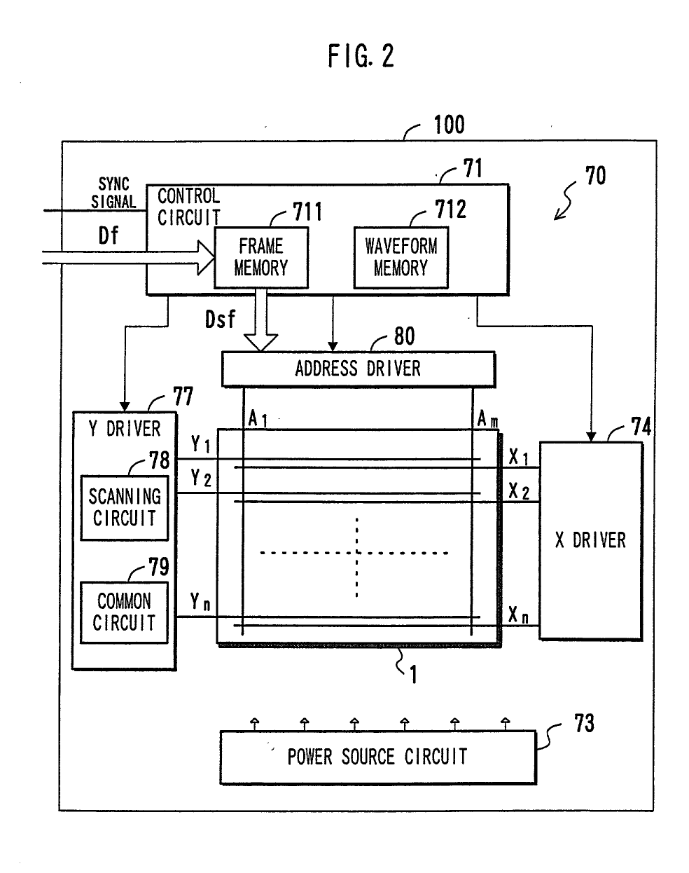

FIG. 2 is a block diagram of a display device according to the present invention.

The display device 100 comprises an AC type PDP 1 having a screen of a three-electrode surface discharge structure including m×n cells and a driving unit 70 for letting each cell emit light selectively. The display device 100 can be used as a wall-hung television set or a display monitor of a computer system.

In the PDP 1, display electrodes X and display electrodes Y extend in the same direction (in the horizontal direction), and the neighboring display electrodes X and Y (a pair) control the light emission of one display line. In addition, address electrodes A for selecting cells of each display line are arranged so as to cross the display electrodes.

The driving unit 70 includes a control circuit 71 for driving control, a power source circuit 73, an X driver 74, a Y driver 77 and an address driver 80. The driving unit 70 supplied with frame data Df that are multivalue image data indicating luminance levels of red, green and blue colors from external equipment such as a TV tuner or a computer, along with various synchronizing signals. The control circuit 71 includes a frame memory 711 for memorizing the frame data Df temporarily and a waveform memory 712 for memorizing control data of the driving voltage.

As widely known, in a PDP display, each of the sequential frames or fields (in the case where the input is an interlace form) of an input image is divided into a predetermined number of subfields for performing a gradation reproduction by a binary lighting control. The frame data Df are stored in the frame memory 711 temporarily and transferred to an address driver 80 after being converted into subfield data Dsf for the gradation display. The subfield data Dsf are display data of q bits indicating q subfields (a set q screen, each of which includes display data of one bit per one cell). The subfield is a binary image having a resolution of m×n. The value of each bit of the subfield data Dsf indicates whether the light emission of the cell in the corresponding subfield is necessary, more exactly whether the address discharge is necessary.

The X driver 74 controls potentials of the n display electrodes X as a unit. The Y driver 77 includes a scanning circuit 78 for the addressing and a common driver 79 for the display discharge. The scanning circuit 78 is scan pulse applying means for line selection. The address driver 80 controls potentials of m address electrodes A in accordance with the subfield data Dsf. These drivers are supplied with a predetermined electric power from the power source circuit 73 via conductive wires (not shown).

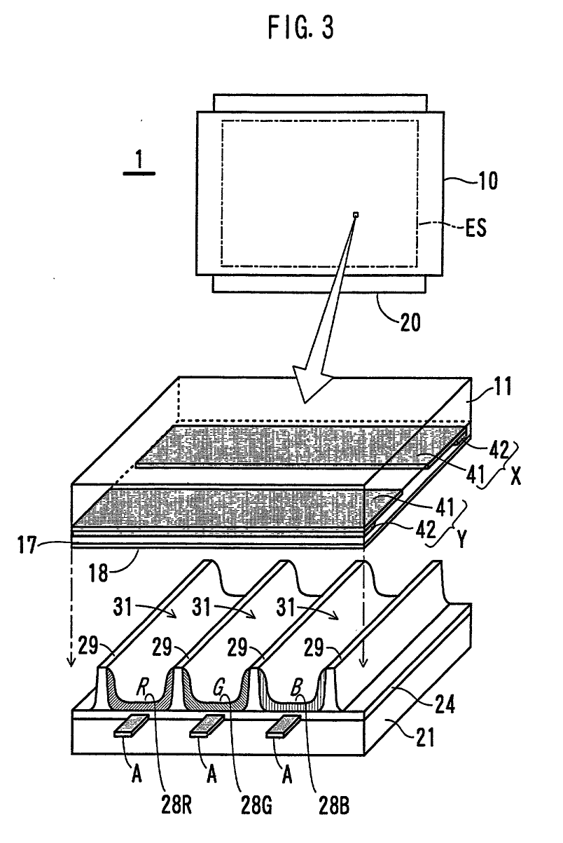

FIG. 3 is a diagram showing a cell structure of a PDP according to the present invention. FIG. 3 shows a pair of substrate structures that are separated for showing an inner structure.

PDP 1 comprises a pair of substrate structure (a structure including a substrate and elements of discharge cells arranged on the substrate) 10, 20. The display electrodes X, Y are arranged on the inner surface of a front glass substrate 11. Each of the display electrodes X, Y includes a transparent conductive film 41 that forms a surface discharge gap and a metal film (a bus electrode) 42 extending over the entire length of the screen in the horizontal direction. The display electrodes X, Y are covered with a dielectric layer 17 having the thickness of approximately 30-50 μm, and the surface of the dielectric layer 17 is covered with a protection film 18 made of magnesia (MgO). The address electrodes A are arranged on the inner surface of the rear glass substrate 21 and covered with a dielectric layer 24. On the dielectric layer 24, band-like partitions 29 having the height of approximately 150 μm are arranged, and these partitions 29 divide the discharge space into plural columns. A column space 31 of the discharge space corresponding to each column is continuous over all display lines. The inner surface of the rear side including sides of the partition 29 is covered with fluorescent material layers 28R, 28G, and 28B of red, green and blue colors for color display. Italic alphabet characters R, G, B in the figure indicate light emission colors of the fluorescent materials. The fluorescent material layers 28R, 28G, 28B are excited locally by ultraviolet rays generated by the discharge gas so as to emit light. The partition can have a grid shape that defines discharge spaces for discharge cells.

[Driving Method]

### [EXAMPLE 1]

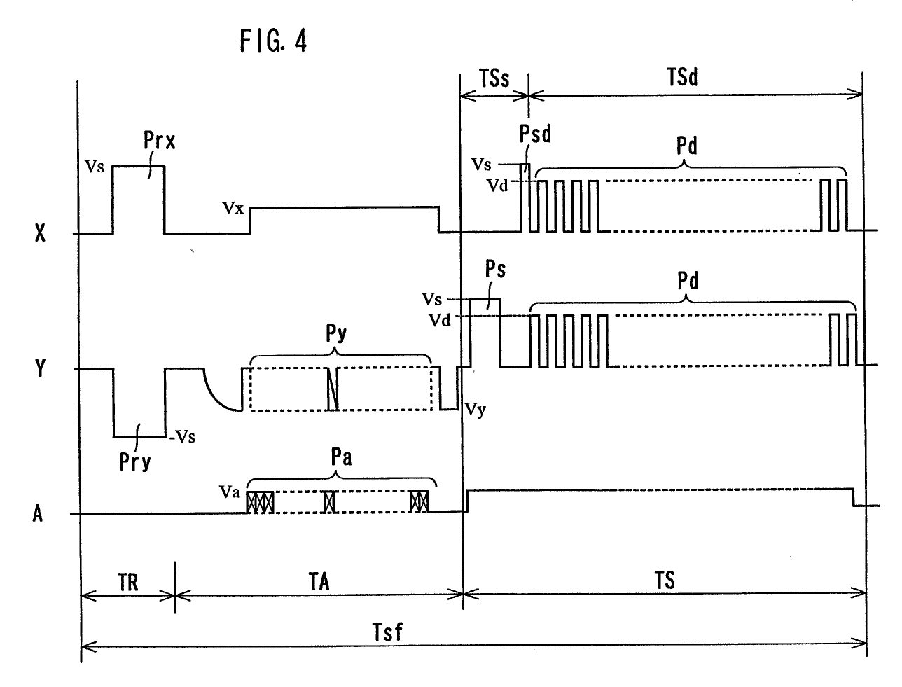

FIG. 4 is a diagram showing voltage waveforms according to a first example of the present invention.

In the first example, the AC pulse memory driving method is used for performing the gradation display by a method of separating the addressing and the display discharge in a temporal manner (ADS: Address Display Separation).

The subfield period Tsf that is assigned to each subfield of the frame includes a reset period TR for initializing the charge of the entire screen, an address period TA for the addressing and a sustaining period TS for generating the display discharge.

In the reset period TR, a voltage of approximately twice the sustaining voltage Vs (i.e., approximately 340 volts) is applied between the display electrodes (hereinafter, referred to as between X and Y) of all display lines, so that a strong discharge is generated in all cells. In the figure, pulses Prx and Pry having opposite polarities are applied to the display electrode X and the display electrode Y. When the application of the voltage is stopped, the accumulated wall charge causes a self-erasing discharge and the wall charge decays.

In the address period TA, a scan pulse Py (the peak value Vy thereof is approximately −140 volts) to the display electrodes Y one by one, while an address pulse Pa (the peak value Va thereof is approximately 60 volts) is applied to a specific address electrode A that is selected by the subfield data of the selected display line. Namely, the wall charge is formed in the cell to be lighted in the sustaining period TS. The display electrode X is biased to an appropriate potential Vx so as to prevent an undesired discharge. The above-mentioned sequence is the same as that in the wall charge memory driving method.

The sustaining period TS includes a stabilizing period TSs and an AC pulse memory drive period TSd. In the stabilizing period TSs, a sustaining pulse Ps having the pulse width of several μsec is applied between X and Y, so that the discharge occurs only in the cell having the wall charge generated by the addressing. One to several times of discharge stabilizes the electrification, and the following discharge can start quickly responding to an application of a pulse. At the end of the stabilizing period TSs, a sustaining voltage pulse Psd having the pulse width of one micron is applied, so that a discharge occurs securely in the wall charge memory drive format. The voltage pulse Vd having an apposite polarity is applied between X and Y promptly, so as to transfer to the AC pulse memory drive. Since the space charge is remained right after the discharge, a discharge can occur at a voltage that is lower than the sustaining voltage Vs of the wall charge memory drive by 10-30%. When a voltage pulse train having alternating polarity is applied in the period shorter than 2 μsec, the display discharge can last long. The light emission intensity of one display discharge is approximately a half of the light emission intensity in the wall charge memory drive. Since the discharge period is short, the number of pulses can be increased for obtaining higher luminance than the wall charge memory drive.

In this example, in the same way as the conventional wall charge memory driving method, the steps of initialization, addressing and display discharging are performed, and the AC pulse memory drive is performed after the discharge condition becomes stable. Therefore, a driving circuit that is substantially the same as that of the conventional method is used for improving the light emission efficiency that is an advantage of the AC pulse memory drive, reducing the peak current and improving the gradation characteristics by the pulse number correction.

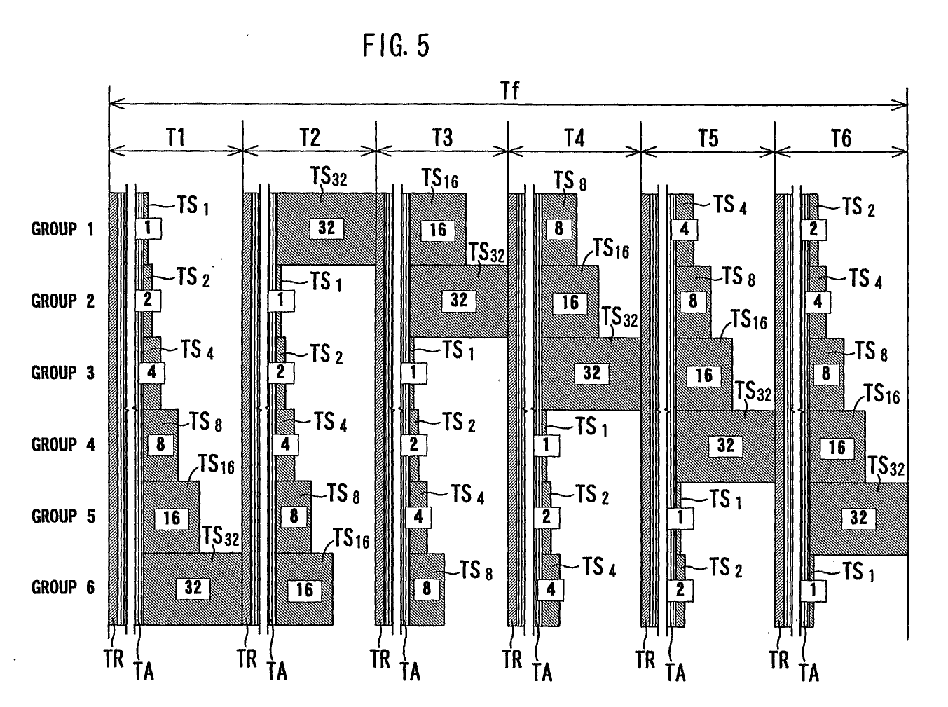

FIG. 5 is a diagram showing an example of the display order of subfields. Numerals (1, 2, 4, 8, 16, 32) enclosed by boxes in the figure and numerals (1, 2, 4, 8, 16, 32) that are suffixes of the reference character TS of the sustaining period indicate weights of the luminance values of the corresponding subfields.

Generally in an ADS format gradation display, the entire of a screen is displayed simultaneously in each subfield. In contrast, in the illustrated sequence, each subfield is divided into plural parts by a display line unit, and is displayed in a time shifting manner one by one part. The display line is divided into groups whose number is the same as that of the subfields (e.g., six). It is possible to divide by a constant number in the order of the arrangement, but it is desirable to divide so that the arrangement order of the display line of each group becomes the discrete number. Using a driving circuit having a structure that is capable of changing the number of pulses to be applied between X and Y for each group, the period Tf assigned to one field is divided into six periods T1-T6.

In each period T1-T6, image information is displayed. The image information is generated by combining parts that correspond to the groups and are extracted from the six subfields so that the groups have different subfields (this is referred to as a “mixed subfield”). Each period T1-T6 corresponds to the subfield period Tsf shown in FIG. 4 and comprises the reset period TR, the address period TA and the sustaining period TS. The length of the sustaining period TS depends on each group.

For each group 1, 2, 3, 4, 5 and 6, the ratio of the numbers of the voltage pulses to be applied in the sustaining period is switched, e.g., 1/2/4/8/16/32 in the period Ti, 32/1/2/4/8/16 in the period T2, and 16/32/1/2/4/8 in the period T3. Thus, a 64 gradation display is performed totally in the six periods T1-T6. Since the moving image pseudo-edge appears in different ways in the groups, the moving image pseudo-edges of the groups are canceled by each other, so that the display quality is improved. However, each of the six periods T1-T6 requires a time for displaying the subfield of the maximum luminance, so the driving time becomes insufficient when the number of display lines increases. In this case, it is effective to decrease the number of groups and disperse the gradation range in which the moving image pseudo-edge occurs easily. The number of the groups is not necessarily equal to the number of subfields. For example, in order to make the driving circuit simple, they are divided into the group of odd display lines and the group of even display lines. One of the groups displays six subfields in the order of the weight of 1/8/16/32/4/2, while the other group displays the subfields in the order of 2/4/32/16/8/1, so that the moving image pseudo-edges are reduced.

### [EXAMPLE 2]

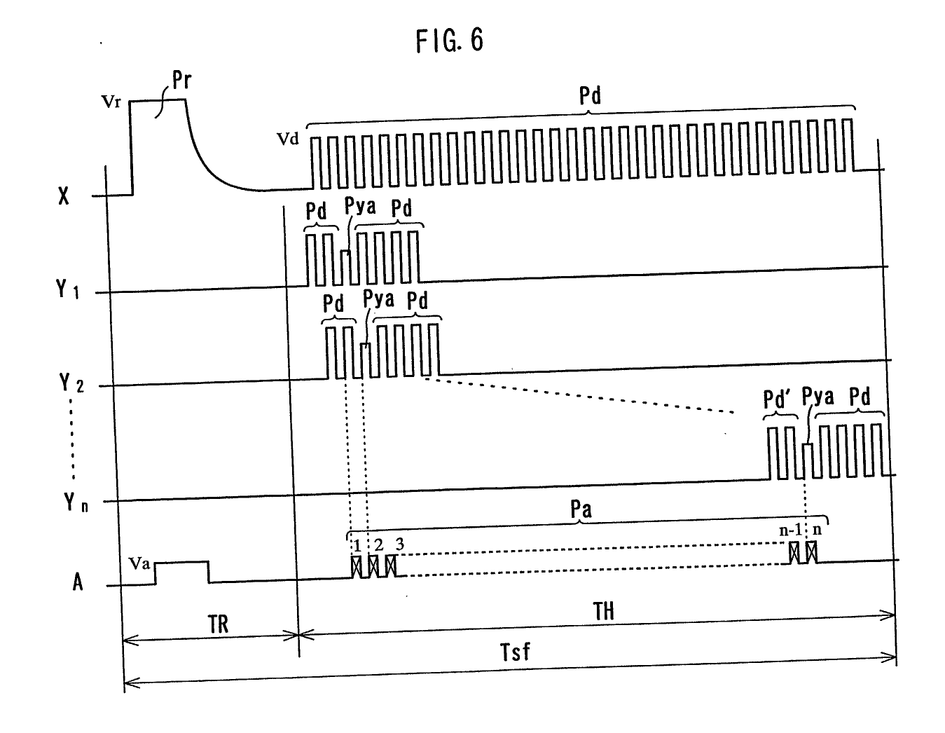

FIG. 6 is a diagram showing voltage waveforms according to a second example of the present invention.

The subfield period Tsf includes the reset period TR and an addressing and sustaining period TH for performing the addressing and the AC pulse memory drive in parallel. In the reset period TR, a pulse Pr is applied to display electrode X, for example. After a voltage (e.g., 300 volts) that is sufficiently higher than the discharge starting voltage is applied to all interelectrodes between X and Y so as to generate a discharge, the applied voltage is dropped gradually in more than 30 μsec. Thus, a lot of wall charge is formed in the dielectric layer that covers the display electrodes X, Y, and a wall voltage that is close to the discharge starting voltage is generated. In this state, the addressing and sustaining period TH starts.

In the addressing and sustaining period TH, an application of a voltage pulse train (the peak value is 130 volts and the pulse width is 1 μsec) to each display line is started while the timing is shifted in the addressing order. Though an excessive discharge is generated just after the start, it becomes an appropriate display discharge gradually. The first several voltage pulses Pd works for stabilizing the discharge. By shifting the start of the application to adjust the number of the stabilizing pulses, the luminance can be equalized between the display lines. If the stabilizing is started at a time for all display lines, the number of the stabilizing pulses increases along with the address order becomes lower, so that the background light emission increases. After stabilizing the discharge, a scan pulse Pya whose peak value is approximately two thirds of the voltage pulse Pd is applied for selecting a display line, and in the synchronization with that, an address pulse Pa whose peak value Va is approximately 60 volts is applied to the address electrode A in accordance with the subfield data of the selected display line. This is an erase format addressing. The display discharge lasts long only in the cell to which the address pulse Pa was applied, and the discharge stops in the other cells. If the non-lighted cell in which the wall charge is erased is in the state of accumulating wall charge having the opposite polarity to the lighted cell, a discharge does not occur even if an address voltage Va is applied to the nonlighted cell by the half selection. A constant voltage pulse Pd is applied to the display electrode X in the period TH, and the number of the voltage pulses Pd to be applied to the display electrode Y is changed for controlling the luminance.

### [EXAMPLE 3]

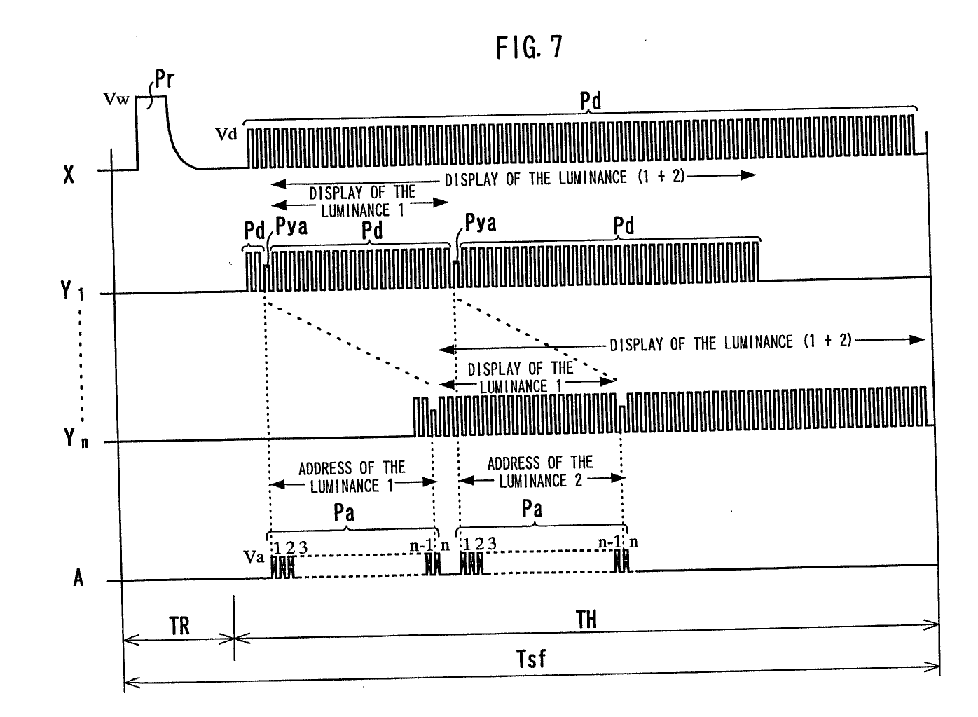

FIG. 7 is a diagram showing voltage waveforms according to a third example of the present invention.

In the same way as the second example, after performing the erasing format addressing, at least one additional addressing (erasing format) is performed. In the illustrated example, the display luminance of the cell whose wall charge was not erased by the first addressing but was erased by the second addressing depends on the number of the electrode pulses Pd that are applied before the erasing. The display luminance of the cell whose wall charge was not erased by either the first or the second addressing depends on the total number of the electrode pulses Pd that are applied to the addressing and sustaining period TH. The gradation number of the display is the value of the number determined by the subfield division multiplied by the number of addressing times per the subfield.

In this example, compared with the case where the initialization is performed for each addressing, the number of the initialization times per a frame decreases. Therefore, the luminance of the background light emission decreases and a contrast is improved.

### [EXAMPLE 4]

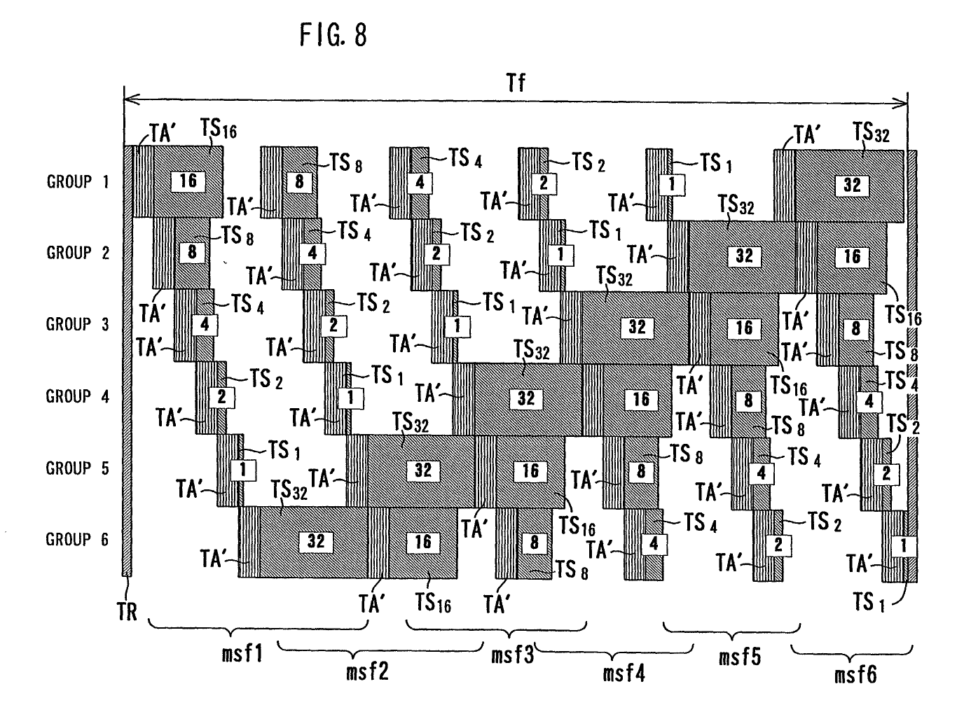

FIG. 8 is a diagram showing the display order of the subfield according to a fourth example.

In the same way as the example shown in FIG. 5, the display lines are divided into groups of the number that is the same as the number of subfields (e.g., six). A part corresponding to each group is extracted from each of the six subfields and is combined. Namely, the six subfields are recombined to six mixed subfields msf1-msf6 for display. In the example of FIG. 5, an independent period T1-T6 is assigned to each of the mixed subfields. However, in the present example, the mixed subfields msf1-msf6 are addressed sequentially. The AC pulse memory drive is started from the display line that has finished the addressing in turn. The display period of a mixed subfield is overlapped with that of the succeeding mixed subfield.

The length of the field period Tf is more than the sum of the necessary time for the six addressing and the length of the sustaining period TS₁ of the sixth group that is addressed at the end of the mixed subfield msf6 that is displayed last. Therefore, the display order should be arranged so that the last sixth group of the last mixed subfield msf6 becomes the subfield having the minimum weight of the luminance. Thus, the time that can be assigned to the addressing becomes long, so that the number of the subfields can be increased to make a multi-gradation.

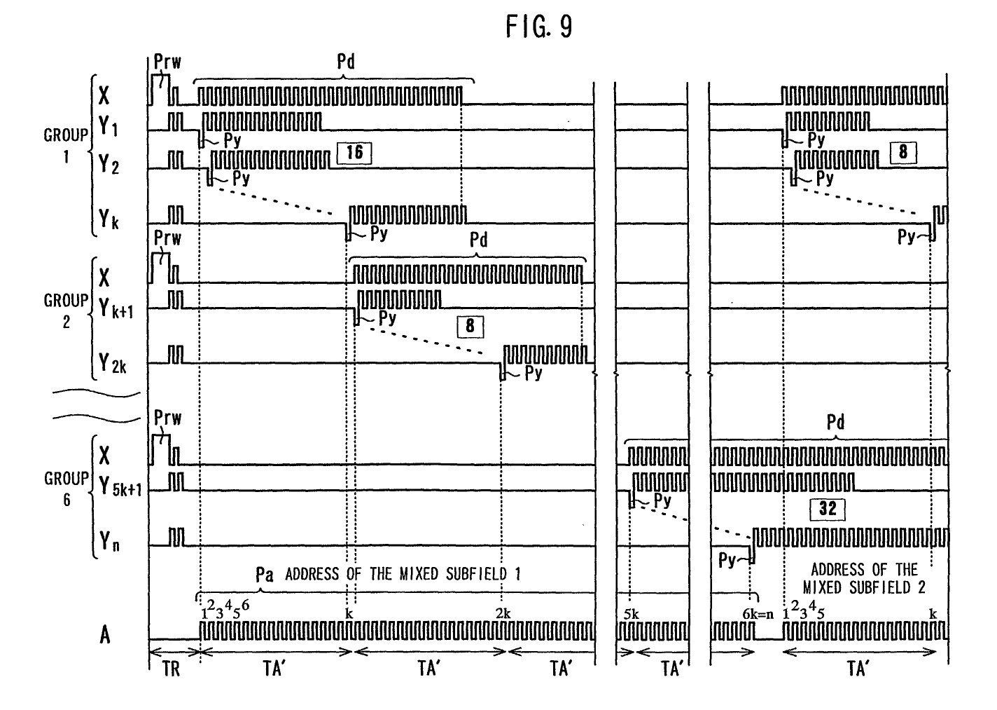

FIG. 9 is a diagram showing voltage waveforms of the fourth example.

A reset pulse Prw is applied between X and Y, and a voltage pulse Vd for the AC pulse memory drive is applied just after the self-erasing. After halting the discharge temporarily, a voltage pulse Vd is applied to the display electrode X, and a scan pulse Py is applied to the display electrode Y. In addition, an address pulse Pa is supplied to the specific address electrode A determined by the subfield data so that an address discharge is generated. While a discharge can be generated easily due to the space charge generated by the address discharge, the application of the voltage pulse train is started so as to generate display discharges whose number of times corresponds to the luminance.

In this example, since the display discharge is generated in one group while the addressing is performed in the other group, a high speed driving can be realized compared with the ADS format. The addressing speed is approximately 2 μsec per one line. If the number of the display lines is 1000, a display of eight subfields and 256 gradations can be realized in the field period of 16.7 ms without separating the screen into the upper and the lower portions.

The recombination to the mixed subfields and the dispersion of the subfield has advantages in that the moving image pseudo-edges are reduced and that the concentration of the current, i.e., the power consumption in one time of the field period Tf can be eliminated. Namely, since a peak power can be supplied from the capacitor so that the requirement of current supplying ability (the rating of the load) to transformers and transistors is relieved, the power source circuit can be constituted with compact and inexpensive devices.

In order to prevent a discharge error due to the half selection, it is desirable to set the voltage so that the charged state before the addressing is as close as possible to that after the application of the voltage pulse train. In an AC pulse memory drive that utilizes the wall charge, the remaining wall charge after the display discharge of the number of times corresponding to the luminance causes a malfunction. Especially, the wall charge on the wall surface that is apart from the discharge area is remained easily without being neutralized by the initialization process. In order to suppress the remaining wall charge to a small quantity, it is effective to switch the polarity of the reset pulse Prw for each field and to switch the polarity of the final pulse of the voltage pulse train regularly.

According to the driving method of the present invention, the display discharge can be generated by lower voltage than the conventional method, so that the efficiency of the light emission can be improved. In addition, a high definition display in which moving image pseudo-edges are not conspicuous can be realized. Furthermore, by dividing a frame into more subfields, the reproducibility of the gradation can be improved. In addition, decreasing the number of the initialization times with an undesired light emission, the background light emission can be reduced and the contrast can be improved. Moreover, the moving image pseudo-edges can be reduced more securely.

While the presently preferred embodiments of the present invention have been shown and described, it will be understood that the present invention is not limited thereto, and that various changes and modifications may be made by those skilled in the art without departing from the scope of the invention as set forth in the appended claims.

What is claimed is:

1. A method for driving an AC type PDP, comprising the steps of:
utilizing a wall charge for generating a display discharge; and
applying a voltage pulse train having alternating polarity between display electrodes so that the display discharge is generated at a time interval in which space charge causes an active priming effect and that the polarity of the wall voltage between the display electrode switches for every display discharge.

2. The method according to claim 1, wherein a wall charge accumulating time for one pulse is longer than 0.3 μsec, an application suspending period between one pulse and the next pulse is shorter than 0.3 μsec, and the time interval is within the range of 0.3-2.0 μsec.

3. A method for driving an AC type PDP, comprising the steps of:
utilizing a wall charge for generating a display discharge;
applying a voltage that is higher than a discharge starting voltage between display electrodes so as to generate a discharge;
utilizing the wall charge that was formed by the discharge in the preceding step so as to generate a discharge by applying a voltage that is lower than the discharge starting voltage; and
applying a voltage pulse train having alternating polarity between the display electrodes so that the display discharge is generated at a time interval in which space charge causes an active priming effect and that the polarity of the wall voltage between the display electrodes switches for every display discharge.

4. A method for driving an AC type PDP, comprising the steps of:
dividing a frame into plural subfields so as to perform a gradation display;
assigning an address period and a display period that are separated from each other temporally to each subfield;
utilizing a wall charge in the display period for generating a display discharge;
forming the wall charge in the address period in the cell to be lighted in the succeeding display period;
applying a voltage that is lower than the discharge starting voltage between display electrodes so as to generate a discharge in the display period; and
applying a voltage pulse train having a lower peak value than the voltage of the preceding step and alternating polarity between the display electrodes so that the display discharge is generated at a time interval in which space charge causes an active priming effect and that the polarity of the wall voltage between the display electrodes switches for every display discharge.

5. The method according to claim 4, further comprising the steps of dividing a display line into plural groups, and displaying the plural subfields in the order that is different between the groups.

6. A method for driving an AC type PDP, comprising the steps of:
utilizing a wall charge for generating a display discharge;
selecting a display line for addressing in a predetermined order; and
applying a voltage pulse train having alternating polarity between the display electrodes of the display line in which the addressing is finished in turn, so that the display discharge is generated at a time interval in which space charge causes an active priming effect and that the polarity of the wall voltage between the display electrodes switches for every display discharge.

7. The method according to claim 6, further comprising the steps of applying a voltage that is higher than a discharge starting voltage so as to generate a discharge, then dropping the applied voltage gradually so as to form the charged state just before the start of the discharge, and performing an addressing of erasing format.

8. The method according to claim 6, further comprising the step of performing at least one additional addressing during the application of the voltage pulse train so as to perform a gradation display.

9. The method according to claim 6, further comprising the step of dividing a frame into plural subfields so as to perform a gradation display, weighting of luminance to each subfield, performing a gradation display by generating display discharges of the number of times corresponding to the weight of the luminance for each subfield, wherein a display line is divided into plural groups, and the plural subfields are displayed in the order that is different between the groups.

10. The method according to claim 7, wherein the neighboring display lines are distributed to different groups.
